(19) United States
(12) Patent Application Publication
(10) Pub. No.: US 2023/0191363 A1
(43) Pub. Date: Jun. 22, 2023

(54) FILTER FOR WATER PURIFIER AND WATER PURIFIER INCLUDING SAME

(71) Applicant: LG ELECTRONICS INC., Seoul (KR)

(72) Inventors: Yuseung CHOI, Seoul (KR); Sangduck LEE, Seoul (KR); Jongpil KIM, Seoul (KR); Suhye WOO, Seoul (KR)

(21) Appl. No.: 17/927,143

(22) PCT Filed: Apr. 7, 2021
(86) PCT No.: PCT/KR2021/004348

§ 371 Date: Nov. 22, 2022

(30) Foreign Application Priority Data
May 22, 2020 (KR) 10-2020-0061721

(51) Int. Cl. B01J 20/20; C02F 1/28; C02F 1/44; B01D 35/30; B01D 39/14; B01D 63/02

(52) U.S. Cl. CPC B01J 20/20; C02F 1/283; C02F 1/444; B01D 35/30; B01D 39/14; B01D 63/02; B01D 2239/0618

(57) ABSTRACT

A filter for a liquid purifier may include a filter housing having an inlet and an outlet; and a filter module provided in the filter housing, and configured to purify liquid introduced through the inlet, and to supply the purified liquid to the outlet. The filter module may include an electrostatic adsorption nonwoven fabric having a hollow portion. The filter module may be configured to receive the liquid introduced through the inlet is to pass through the electrostatic adsorption nonwoven fabric and then is to discharge out of the outlet of the filter housing.

### CROSS-REFERENCE TO RELATED PATENT APPLICATIONS

This application is a U.S. National Stage Application under 35 U.S.C. § 371 of PCT Application No. PCT/KR2021/004348, filed Apr. 7, 2021, which claims priority to Korean Patent Application No. 10-2020-0061721, filed May 22, 2020, whose entire disclosures are hereby incorporated by reference.

### TECHNICAL FIELD

The present invention relates to a filter for a water purifier having an electrostatic adsorption function and a water purifier having the same.

### BACKGROUND ART

A water purifier refers to a device that purifies raw water such as tap water or groundwater. That is, the water purifier refers to a device for converting raw water into drinking water through various purification methods to provide the drinking water. To generate purified water, processes such as precipitation, filtration, and sterilization may be performed, and thus harmful substances are generally removed through these processes.

A water purifier may be provided with various filters to purify raw water. The filters may be classified into a sediment filter, an activated carbon filter, a UF hollow fiber membrane filter, an RO membrane filter, and the like according to their functions.

The sediment filter may be called a filter for precipitating contaminants or suspended materials with large particles in the raw water, and the activated carbon filter may be called a filter for adsorbing and removing contaminants with small particles, residual chlorine, volatile organic compounds or odor generating factors.

The activated carbon filter may be provided with two filters. That is, the activated carbon filter may be provided with a pre-activated carbon filter provided at a raw water-side and a post-activated carbon filter may be provided at a purified water-side. The post-activated carbon filter may be provided to improve the taste of water by removing odor-causing substances that mainly affect the taste of purified water.

The UF hollow fiber membrane filter and the RO membrane filter are generally used selectively.

The demand for water purifiers is significantly increasing. Therefore, there is a limitation that various requirements are generated, and it is difficult to satisfy the various requirements at the same time. As an example, heavy metals may be removed by applying the RO membrane filter, but there is a limitation that it is difficult to secure a flow rate of the purified water. That is, there is a limitation that it takes a lot of time to obtain a desired amount of purified water. On the other hand, in the case of the UF hollow fiber membrane filter, a high flow rate may be secured. However, since it is difficult to remove heavy metals in water, there is a limitation that it is difficult to use groundwater or tap water in a contaminated area such as raw water.

The removal of the heavy metals and the securing of the high flow rate are inevitably recognized as contradictory problems. This is because it may be difficult to secure the high flow rate when using the RO membrane filter to remove the heavy metals, and it may be difficult to remove the heavy metals when using the UF hollow fiber membrane filter to secure the high flow rate.

In an example disadvantageous arrangement, when using a carbon block as a single filter, it may be difficult to remove viruses and bacteria, and when several filters are individually provided, there may be a limitation in that a volume of the filter increases.

Since an UF filter (ultrafiltration filter) or an electrostatic adsorption filter is a chemical product, an issue may occur that the taste of water changes when the filter is applied last.

Virus removal performance may be affected by the quality of the raw water. In overseas regions, quality of raw water is often worse than that of domestic water. Therefore, other particulate materials, total dissolved solids (TDS), turbidity substances, etc. contained in the raw water may interfere with the role of the electrostatic adsorption material to remove viruses, which may cause performance degradation. To compensate, it may be necessary to increase in specific surface area of the electrostatic adsorption material.

### Technical Problem

The present invention for solving the above limitations may provide a filter for a water purifier, in which water introduced into a filter housing passes through an electrostatic adsorption filter with an increasing surface area and then is discharged to the outside of the filter housing to reliably remove viruses, bacteria, particulate materials, etc., and a water purifier including the same.

The present invention may provide a filter for a water purifier, in which water introduced into a filter housing passes through a wrinkled electrostatic adsorption filter or a multi-layered electrostatic adsorption filter and then is discharged to the outside of the filter housing, and a water purifier including the same.

The present invention may provide a filter for a water purifier, in which a passage is secured so that water introduced into a filter housing sequentially passes through an electrostatic adsorption filter and a carbon block and then is discharged to the outside of the filter housing, and a water purifier including the same.

The present invention may provide a filter for a water purifier, in which a passage is secured so that water introduced into a filter housing sequentially passes through a UF filter, an electrostatic adsorption filter, and a carbon block and then is discharged to the outside of the filter housing, and a water purifier including the same.

The present invention may provide a filter for a water purifier, in which a UF filter, an electrostatic adsorption filter, and a carbon block are disposed in one filter housing, and a water purifier including the same.

The present invention may provide a filter for a water purifier which is capable of more reliably removing particulate materials, bacteria, and viruses contained in water, and a water purifier including the same.

The present invention may provide a filter for a water purifier which does not change taste of water finally supplied to a user, and a water purifier including the same.

The present invention may provide a filter for a water purifier which is capable of being directly applied to an existing water purifier without changing a shape or arrangement structure of a filter applied to the water purifier, and a water purifier including the same.

The present invention may provide a filter for a water purifier in which heterogeneous filters are disposed in a filter housing in a longitudinal direction to reduce a volume of the filters, thereby improving space utilization, and a water purifier including the same.

### Technical Solution

A filter for a water purifier according to the present invention includes a filter housing provided with an inlet and an outlet, and a filter module provided in the filter housing to purify water introduced through the inlet, thereby supplying the purified water to the outlet.

The filter module includes an electrostatic adsorption nonwoven fabric having a hollow portion.

Wrinkles are disposed along a circumferential direction of the electrostatic adsorption nonwoven fabric.

The water introduced into the filter housing passes through the electrostatic adsorption nonwoven fabric and then is discharged out of the filter housing.

The electrostatic adsorption nonwoven fabric includes a plurality of convex portions convexly protruding outward, and a concave portion provided between the convex portions.

The electrostatic adsorption nonwoven fabric includes powdered activated carbon.

The electrostatic adsorption nonwoven fabric is configured to define a closed curve by crimping a rectangular nonwoven fabric and thermally fusing both ends of the rectangular nonwoven fabric in a state in which both the ends are in contact with each other.

The electrostatic adsorption nonwoven fabric are provided in multiple layers.

The filter may further include a second electrostatic adsorption nonwoven fabric configured to surround an outer circumference of the electrostatic adsorption nonwoven fabric.

The filter may include a carbon block having a hollow tube shape, which is provided by processing a mixture containing activated carbon and a binder and is disposed in the hollow portion.

In the filter module, the carbon block is disposed in the hollow portion of the electrostatic adsorption nonwoven fabric.

The electrostatic adsorption nonwoven fabric is provided to surround an outer circumferential surface of the carbon block.

The water introduced into the filter housing first passes through the electrostatic adsorption nonwoven fabric and passes through the carbon block and then is discharged out of the filter housing.

In the electrostatic adsorption nonwoven fabric, wrinkles are disposed on a circumference of the carbon block.

The electrostatic adsorption nonwoven fabric includes a plurality of convex portions convexly protruding outward the carbon block, and a concave portion provided between the convex portions.

In the filter housing, a hollow fiber membrane (UF) filter is disposed below the electrostatic adsorption nonwoven fabric.

The water introduced into the filter housing first passes through the hollow fiber membrane (UF) and then passes through the electrostatic adsorption nonwoven fabric and the carbon block.

A first inner cover configured to define an outer appearance of the hollow fiber membrane filter and cover a hollow fiber membrane is accommodated in the filter housing.

A second inner cover disposed above the first inner cover and configured to cover an outside of the electrostatic adsorption nonwoven fabric is accommodated in the filter housing.

A communication hole through which an inside and an outside of the first inner cover communicate with each other is defined in the first inner cover.

The water introduced into the filter housing flows downward from an upper side along a first passage provided between an inner surface of the filter housing and outer surfaces of the first and second inner covers and is introduced into the first inner cover through the communication hole.

The water introduced into the first inner cover is filtered while passing through the hollow fiber membrane (UF) filter, is discharged to an upper side of the hollow fiber membrane (UF) filter, and is introduced into the second inner cover.

A filter bracket coupled to a lower end of the electrostatic adsorption nonwoven fabric and the carbon block is seated on an upper end of the hollow fiber membrane (UF) filter.

The water discharged to the upper side of the hollow fiber membrane (UF) filter flows through a second passage provided between the upper side of the hollow fiber membrane (UF) filter and the filter bracket.

The filter bracket include an extension portion protruding downward along a circumference, wherein a through-groove concavely defined upward from a lower end of the extension portion is defined in the extension portion.

The water flowing through the second passage is discharged through the through-hole defined by the through-hole and the upper end of the hollow fiber membrane (UF) filter and is introduced into a third passage provided between the electrostatic adsorption nonwoven fabric and the second inner cover.

The water introduced into the third passage passes through the electrostatic adsorption nonwoven fabric, is introduced into a hollow of the carbon block, and is discharged to the outside of the filter housing while flowing upward.

An upper end of the first inner cover is inserted into a lower end of the second inner cover, and a sealing member is inserted between the upper end of the first inner cover and the lower end of the second inner cover.

The electrostatic adsorption nonwoven fabric is configured to define a closed curve by crimping a rectangular nonwoven fabric and thermally fusing both ends of the rectangular nonwoven fabric in a state in which both the ends are in contact with each other and then is fitted to surround an outer circumferential surface of the carbon block.

A water purifier according to the present invention is provided with a filter for a water purifier according to the various embodiments.

### Advantageous Effects

According to the present invention, there may be the effect that the water introduced into a filter housing passes through the electrostatic adsorption filter with the increasing surface area and then is discharged to the outside of the filter housing to reliably remove the viruses, the bacteria, the particulate materials, etc., and improve the filtration performance.

According to the present invention, there may be the effect that the water introduced into the filter housing passes through the wrinkled electrostatic adsorption filter and then is discharged to the outside of the filter housing to increase in electrostatic adsorption capacity and improve the filtration performance.

According to the present invention, there may be the effect that the water introduced into the filter housing passes through the multi-layered electrostatic adsorption filter and then is discharged to the outside of the filter housing to increase in electrostatic adsorption capacity and improve the filtration performance.

According to the present invention, there may be the effect that the passage is secured so that the water introduced into the filter housing sequentially passes through the electrostatic adsorption filter and the carbon block and then is discharged to the outside of the filter housing.

According to the present invention, there may be the effect that the passage is secured so that the water introduced into the filter housing sequentially passes through the UF filter, the electrostatic adsorption filter, and the carbon block and then is discharged to the outside of the filter housing.

According to the present invention, there may be the effect that the UF filter, the electrostatic adsorption filter, and the carbon block are disposed in the one filter housing.

According to the present invention, there may be the effect that the specific surface area of the electrostatic adsorption nonwoven fabric increases to expand the filter lifespan.

According to the present invention, there may be the effect that the particulate materials, the bacteria, and the viruses contained in water are more reliably removed.

According to the present invention, there may be the effect that the taste of the water finally supplied to the user is not changed.

According to the present invention, there may be the effect that the water purification process is performed several times by the plurality of filters to more reliably remove the various foreign substances in addition to the heavy metals.

According to the present invention, there may be the effect that, since only the material of the filter is changed, and the shape or arrangement structure of the filter applied to the water purifier is not changed, the filter is capable of being directly applied to the existing water purifier.

According to the present invention, there may be the effect that the heterogeneous filters are in the one filter housing in the longitudinal direction to reduce the volume of the filters, thereby improving the space utilization and more realizing the slimness of the water purifier.

### BRIEF DESCRIPTION OF THE DRAWINGS

Arrangements and embodiments of the present disclosure may become apparent from the detailed description of the following aspects in conjunction with the accompanying drawings, in which:

FIG. 1 is a water pipe diagram of a water purifier according to an embodiment of the present invention;

FIG. 2 is a conceptual view of a filter assembly that is a portion of components of the present invention;

FIG. 3 is a cross-sectional view of a pre-filter that is a portion of the components of the present invention;

FIG. 4 is a cross-sectional view illustrating an example of a composite filter that is a portion of the components of the present invention;

FIG. 5 is a perspective view illustrating an example of a post-filter from which a second inner cover is separated;

FIG. 6 is a top plan view illustrating the example of the post-filter from which the second inner cover is separated;

FIG. 7 is a cross-sectional view illustrating another example of the composite filter that is the portion of the components of the present invention;

FIG. 8 is a perspective view illustrating another example of the post-filter from which the second inner cover is separated;

FIG. 9 is a top plan view illustrating another example of the post-filter from which the second inner cover is separated;

FIG. 10 is a perspective view illustrating a state in which the post-filter and a hollow fiber membrane filter are coupled to each other in the state illustrated in FIG. 8;

FIG. 11 is a perspective view illustrating a state in which the post-filter and the hollow fiber membrane filter are coupled to each other;

FIG. 12 is a table showing components to be removed for each material constituting the composite filter; and

FIG. 13 is a view illustrating a mechanism in which chromium (Cr) and selenium (Se) are removed from an electrostatic adsorption nonwoven fabric.

### DETAILED DESCRIPTION

Hereinafter, specific embodiments may be described in detail with reference to the accompanying drawings. Embodiments may, however, be embodied in many different forms and should not be construed as being limited to the embodiments set forth herein, and a person of ordinary skill in the art, who understands the spirit of the present invention, may readily implement other embodiments included within the scope of the same concept by adding, changing, deleting, and adding components; rather, it will be understood that they are also included within the scope of the present invention.

The drawings attached to the following embodiments are embodiments of the scope of the invention, but to facilitate understanding within the scope of the present invention, in the description of the fine portions, the drawings may be expressed differently according to the drawings, and the specific portions may not be displayed according to the drawings, or may be exaggerated according to the drawings.

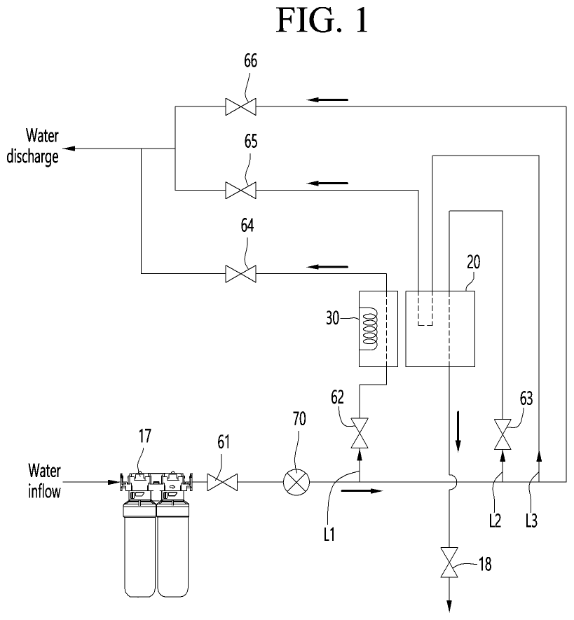

FIG. 1 is a water pipe diagram of a water purifier according to an embodiment of the present invention. The following disclosure may describe use of water and a water purifier. However, embodiments may relate to use of another liquid and a liquid purifier. A water purifier (or liquid purifier) according to the present invention may be configured to purify water (or liquid) directly supplied from an external water source to cool or heat the water to be dispensed. For example, the water purifier may be a direct type hot and cold water purifier (or liquid purifier).

The direct type water purifier represents a water purifier in which water is dispensed when a user performs a water dispensing operation without having a water tank in which purified water is stored.

The water purifier may be formed integrally with a refrigerator, for example. The water purifier may be provided with an undersink-type water purifier in which a main body is installed under a sink, and a water outlet is installed outside the sink.

Referring to FIG. 1, in the water purifier according to an embodiment of the present invention, a water supply line L may be disposed from a water supply source (or liquid source) to the water outlet of the water purifier, and various valves and water purifying components may be connected to the water supply line L. Embodiments may also relate to liquid purification based on a liquid.

The water supply line is connected to the water supply source (e.g., a faucet in the home), and a filter assembly 17 is disposed at any point of the water supply line to filter foreign substances contained in drinking water supplied from the water supply source.

A water supply valve 61 and a flow rate sensor 70 are successively disposed on the water supply line L connected to an outlet of the filter assembly 17. Thus, when an amount of supplied water, which is detected by the flow rate sensor 70, reaches a set flow rate, the water supply valve 61 may be controlled to be closed.

A water supply line L1 for supplying hot water, a water supply line L3 for supplying cold water, and/or a water supply line L2 for supplying cold water may be branched from any points of the water supply line L extending from the outlet of the water flow sensor 70.

A purified water dispensing valve 66 may be mounted on an end of the water supply line L extending from the outlet end of the flow rate sensor 70. A hot water dispensing valve 64 may be mounted on an end of the water supply line L1 for supplying the hot water. A cold water dispensing valve 65 may be mounted on an end of the water supply line L3 for supplying the cold water. A cold water valve 63 may be mounted at any point of the water supply line L2 for supplying the cold water. The cold water valve 63 adjusts an amount of cold water to be supplied to the cold water generating unit 20 (or cold water generator).

All the water supply lines extending from outlet ends of the hot water dispensing valve 64, the cold water dispensing valve 65, and the purified water dispensing valve 66 are connected to the water outlet. As shown in the drawing, the purified water, the cold water, and the hot water may be dispensed through a single dispensing hole. In some examples, the purified water, the cold water, and the hot water may be dispensed through independent dispensing holes, respectively.

A process of supplying cold water and hot water may be described. In an example of cold water, when the cold water valve 63 is opened to supply cold water to the cold water generating unit 20, water of the water supply line L3 for supplying cold water, which passes through the cold water generating unit 20, may be cooled by coolant to generate cold water.

A refrigerant cycle for cooling the coolant may be provided in the water supply line L2 for supplying the cold water. The refrigerant cycle may include a compressor, a condenser, an expansion valve, and an evaporator, for example.

Thereafter, when a cold water selection button of a manipulation display unit (or display) is pushed to open the cold water dispensing valve 65, the cold water may be dispensed through the water outlet.

In an example of hot water, water flowing along the water supply line L1 for supplying the hot water may be heated by a hot water heater 30 to generate the hot water. When a hot water selection button of the manipulation display unit (or display) is pushed to open the hot water dispensing valve 64, the hot water may be dispensed through the water outlet.

The water purifier having the above-described configuration according to an embodiment of the present invention may include at least one water purifier filter (or liquid purifier filter) to generate purified water from raw water. The water purifier filter may be described with reference to following description.

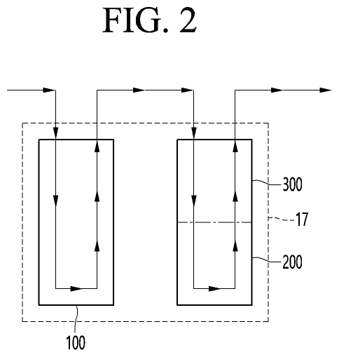

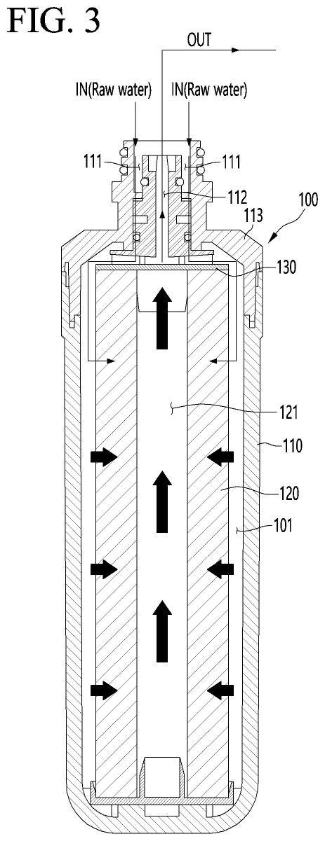

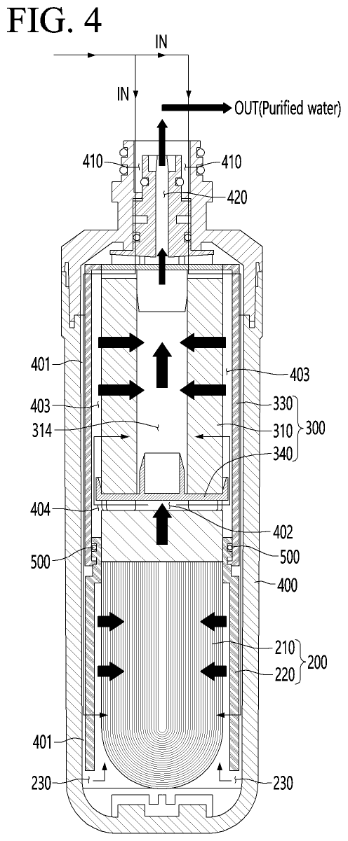

FIG. 2 is a conceptual view of a filter assembly that is a portion of components of the present invention. FIG. 3 is a cross-sectional view of a pre-filter that is a portion of the components of the present invention. FIG. 4 is a cross-sectional view illustrating an example of a composite filter that is a portion of the components of the present invention. The filter for the water purifier (hereinafter referred to as a filter assembly) according to an embodiment of the present invention may include a pre-filter 100 and a filter module (that includes composite filters). The pre-filter 100 has an embedded hollow tube-shaped first carbon block 120. A detailed description of the pre-filter 100 will be described later. The composite filters may include a hollow fiber membrane filter 200 in which a plurality of hollow fiber membranes 210 are embedded, and a post-filter 300 in which an electrostatic adsorption nonwoven fabric 310 is embedded.

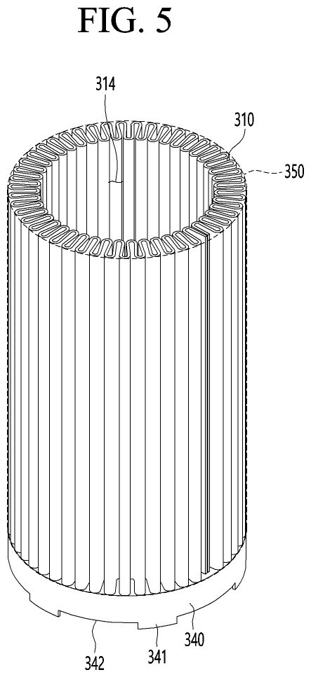

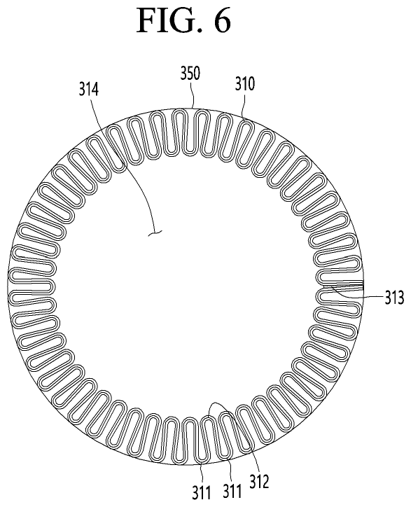

FIG. 5 is a perspective view illustrating an example of the post-filter 300 in which a second inner cover is separated. FIG. 6 is a top plan view illustrating the example of the post-filter 300 in which the second inner cover is separated.

The electrostatic adsorption nonwoven fabric 310 has a hollow portion 314. The electrostatic adsorption nonwoven fabric 310 may have a hollow pipe shape as a whole. The electrostatic adsorption nonwoven fabric 310 may be disposed along an inner circumferential surface of the filter housing 400 or a second inner cover 330 to be described below. The filter module (that includes the electrostatic adsorption nonwoven fabric 310) may be disposed within the filter housing 400.

Water introduced into the filter housing 400 passes through the electrostatic adsorption nonwoven fabric 310 and then is discharged to outside of the filter housing 410.

Wrinkles may be disposed along a circumferential direction of the electrostatic adsorption nonwoven fabric 310. The electrostatic adsorption nonwoven fabric 310 may include a plurality of convex portions 311 that is convex outward and a plurality of concave portions 312 each provided between two of the convex portions. The convex portion 311 or the concave portion 312 may be defined in a radial direction of the hollow portion 314.

The electrostatic adsorption nonwoven fabric 310 may include powdered activated carbon particles.

The electrostatic adsorption nonwoven fabric 310 may define a closed curve by crimping a rectangular nonwoven fabric and thermally fusing both ends of the rectangular nonwoven fabric in a state in which both the ends are in contact with each other.

The electrostatic adsorption nonwoven fabric 310 may be provided in multiple layers.

An outer circumference of the electrostatic adsorption nonwoven fabric 310 may include another electrostatic adsorption nonwoven fabric 350 (or second electrostatic adsorption nonwoven fabric) disposed to surround the outer circumference of the electrostatic adsorption nonwoven fabric.

In the present example, wrinkles are provided on the electrostatic adsorption nonwoven fabric 310. However, the scope of the present invention is not limited thereto, and the electrostatic adsorption nonwoven fabric 310 may not have the wrinkles.

The electrostatic adsorption nonwoven fabric 310 may be provided in a rolling type shape, like a rolled toilet paper.

The electrostatic adsorption nonwoven fabric 310 may be provided in a single layer. Alternatively, the electrostatic adsorption nonwoven fabric 310 may be provided in multiple layers.

As described above, when the electrostatic adsorption nonwoven fabric 310 is provided in a state of being wrinkled, a surface area of the electrostatic adsorption nonwoven fabric 310 may increase, and heavy metals in water may be more reliably removed. When the electrostatic adsorption nonwoven fabric 310 is provided in multiple layers, the heavy metals in water may be more reliably removed.

The electrostatic adsorption nonwoven fabric 310 may define a closed curve by crimping a rectangular nonwoven fabric and thermally fusing both ends of the nonwoven fabric, on which the wrinkles are provided, in a state in which both the ends are in contact with each other. The electrostatic adsorption nonwoven fabric 310 may be provided with a thermal fusion portion 313 to thermally fuse both the ends of the nonwoven fabric.

In this embodiment, the hollow fiber membrane filter 200 and the post-filter 300 may be accommodated in the filter module of the filter housing 400 to constitute the composite filters. The filter module is provided in (or at) the filter housing such that the filter module includes a plurality of elements/components within and including a first inner cover and a second inner cover. The hollow fiber membrane filter 200 and the post-filter 300 may be arranged in a line so that the water passing through the hollow fiber membrane filter 200 passes through the post-filter 300. The hollow fiber membrane filter 200 is disposed at a lower side of the filter housing, and the post-filter 300 is disposed at an upper side of the filter housing. The water introduced into the filter housing 400 sequentially passes through the hollow fiber membrane filter 200 and then the post-filter 300 while flowing from the lower side to the upper side.

The post-filter 300 may include a second inner cover 330 accommodated inside the filter housing 400, and the electrostatic adsorption nonwoven fabric 310 may be accommodated inside the second inner cover 330.

As described above, when the water introduced inside (or into) the second inner cover 330 passes through the electrostatic adsorption nonwoven fabric 310, heavy metals (such as chromium (Cr) and selenium (Se)) in the water may be removed.

FIG. 13 is a view illustrating a mechanism in which chromium (Cr) and selenium (Se) are removed by an electrostatic adsorption nonwoven fabric. More specifically, (a) of FIG. 13 is a view illustrating an electrostatic adsorption mechanism according to a disadvantageous arrangement, and (b) of FIG. 13 is a view illustrating an electrostatic adsorption mechanism using an electrostatic adsorption nonwoven fabric according to the present invention.

Referring to (a) of FIG. 13, there may be a limitation in that an electrostatic adsorption material having a positive charge is used by applying nano-alumina particles 2 on a glass fiber support 1, but there is a risk of dissolving a material such as boron or aluminum.

Referring to (b) of FIG. 13, in example embodiments, the limitation of dissolution safety may be solved (or reduced) by applying the electrostatic adsorption material 310b to which a polyamine-based polymer positive charge functional group is applied to a cellulose support 310a.

For reference, viruses are negatively charged in a tap water state (neutral pH), and when the viruses pass through the filter including the electrostatic adsorption nonwoven fabric 310, the viruses may be removed while being electrostatically adsorbed by the positive charge functional group.

Referring to FIG. 13, when the water introduced into the second inner cover 330 passes through the electrostatic adsorption nonwoven fabric 310, the viruses and fine particles in the water may be adsorbed and removed through the positive charge adsorption.

The electrostatic adsorption nonwoven fabric 310 may also be referred to as a ‘positive charge adsorption nonwoven fabric’ in terms of functionality. The electrostatic adsorption nonwoven fabric 310 is a material different from the ‘anion nonwoven fabric’.

Referring to FIGS. 4 to 5, the hollow fiber membrane filter 200 may be disposed inside the filter housing 400 and below the post-filter 300. The water introduced into the filter housing 400 passes through the hollow fiber membrane filter 200, and then passes through the post-filter 300. Then, the water introduced inside (or into) the second inner cover 330 (of the post-filter 300) passes through the electrostatic adsorption nonwoven fabric 310.

A first inner cover 220 defining an outer appearance of the hollow fiber membrane filter 200 is provided inside the filter housing 400. The hollow fiber membrane filter 200 may include the plurality of hollow fiber membranes 210 and the first inner cover 220 accommodating the hollow fiber membranes 210 therein.

The first inner cover 220 may be disposed below the second inner cover 330. For example, the first inner cover 220 may be detachably coupled to the second inner cover 330. The first inner cover 220 and/or the second inner cover 330 may have a hollow tube shape with upper and lower sides opened.

A communication hole 230 (or communication opening) communicating with the inside and the outside of the first inner cover 220 may be defined based on the first inner cover 220.

The water introduced into the filter housing 400 through the inlet 410 flows upward and downward along a first passage 401 (FIG. 4) provided between an inner surface of the filter housing 400 and an outer surface of each of the first and second inner covers 220 and 330.

The water flowing downward along the first passage 401 may be introduced inside (or into) the first inner cover 220 through the communication hole 230 provided at a lower end of the first inner cover 220. The communication hole 230 may be defined by a spaced distance between a lower end of the first inner cover 220 and an inner bottom surface of the filter housing 400.

The water introduced inside (or into) the first inner cover 220 is filtered while passing through the plurality of hollow fiber membranes 210 (UF), being discharged to an upper side of the hollow fiber membrane filter 200, and then being introduced into the second inner cover 330.

The upper end of the hollow fiber membrane filter 200 may be in an opened state. The water passing through the plurality of hollow fiber membranes 210 naturally flows toward the upper side of the hollow fiber membrane filter 200 based on the flow of the water introduced inside (or into) the first inner cover 220.

A filter bracket 340 coupled to a lower end of the electrostatic adsorption nonwoven fabric 310 is seated on the upper end of the hollow fiber membrane filter 200. The water discharged to the upper side of the hollow fiber membrane filter 200 flows through a second passage 402 (FIG. 4) provided between the upper side of the hollow fiber membrane filter 200 and a bottom surface of the filter bracket 340.

The upper side of the hollow fiber membrane filter 200 and the filter bracket 340 may be maintained in a spaced state. The water passing through the hollow fiber membrane filter 200 may flow through the second passage 402 (FIG. 4) provided in the spaced space.

A lower end of the electrostatic adsorption nonwoven fabric 310 may be fixed to the filter bracket 340 in a hot melt manner.

In order to secure the second passage 402 (FIG. 4), the filter bracket 340 may include an extension portion 341 protruding downward from a circumferential portion of a bottom surface of the filter bracket, and a through-groove 342 defined to be concave upward from a lower end of the extension portion 341. A plurality of through-grooves 342 may be provided on the extension portion.

The bottom surface of the filter bracket 340 and the upper end of the hollow fiber membrane filter 200 may be spaced apart from each other by the extension portion 341, and thus the second passage 402 (FIG. 4) may be secured.

The water flowing through the second passage 402 may be discharged through the through-groove 342 and a through-hole 404 (FIG. 10) defined by the upper end of the hollow fiber membrane filter 200 and then may be introduced into a third passage 403 (FIG. 4) provided between the electrostatic adsorption nonwoven fabric 310 and the second inner cover 330.

The upper end of the hollow fiber membrane filter 200 and the filter bracket 340 are in a state of being accommodated under the second inner cover 330. Thus, the water flowing through the second passage 402 may be discharged through the through-hole 404 (FIG. 10) and then be introduced into the third passage 403 (FIG. 4).

The water introduced into the third passage 403 passes through the electrostatic adsorption nonwoven fabric 310 and then is introduced into the hollow portion 314 so as to flow upward. The water is then discharged through the outlet 420 of the filter housing.

An upper end of the first inner cover 220 may be inserted into (or coupled to) a lower end of the second inner cover 330. A sealing member 500 (or sealant) may be inserted between the upper end of the first inner cover 220 and the lower end of the second inner cover 330.

An accommodation groove that is concave inward to accommodate the sealing member 500 may be defined in a surface facing an outer surface of the first inner cover 220 or an inner surface of the second inner cover 330.

As a modified example, the lower end of the second inner cover 330 may be inserted into the upper end of the first inner cover 220.

The first inner cover 220 and the second inner cover 330 may be integrally formed.

A flow process of water introduced into the composite filters and configured as described above may be described. Water may be introduced through the inlet 410 provided at the upper side of the filter housing 400. For example, the introduced water may be water that has passed through the pre-filter 100.

The water introduced into the inlet 410 flows downward from the upper side along the first passage 401 provided between the outer surfaces of each of the first and second inner covers 220 and 330 and the inner surface of the filter housing 400.

The water of the first passage 401 is introduced into (or inside) the first inner cover 220 through the communication hole 230 provided below the first inner cover 220. The water introduced into (or inside) the first inner cover 220 passes through the plurality of hollow fiber membranes 210 (accommodated within the first inner cover 220) and is filtered, and then is discharged toward the upper side.

The water discharged from the upper side of the hollow fiber membrane 210 flows through the second passage 402 provided between the upper end of the hollow fiber membrane filter 200 and the filter bracket 340, and is discharged through the through-hole 404 (FIG. 10).

The water passing through the through-hole 404 (FIG. 10) is introduced into the third passage 403 provided between the inner surface of the second inner cover 330 and the electrostatic adsorption nonwoven fabric 310. The water introduced into the third passage 403 may pass through the electrostatic adsorption nonwoven fabric 310 and then be discharged through the outlet 420 provided at a upper center of the filter housing 400.

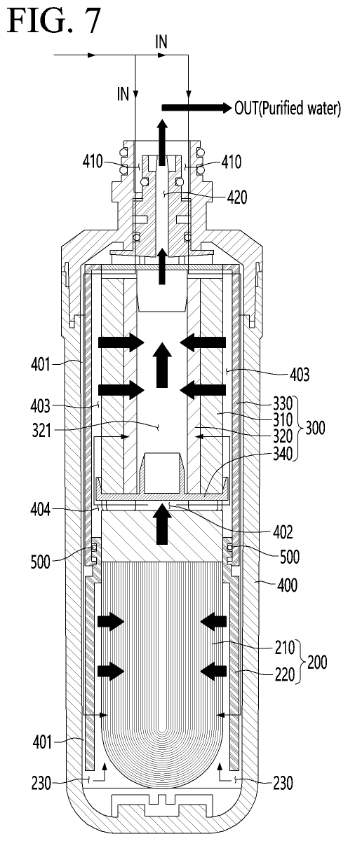

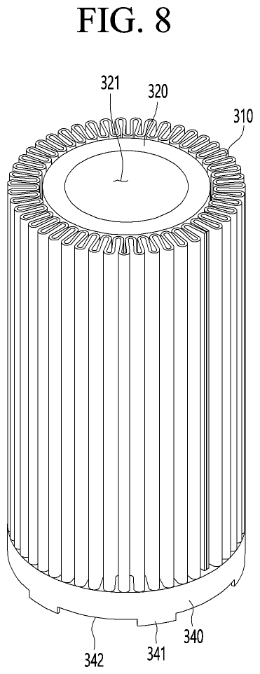

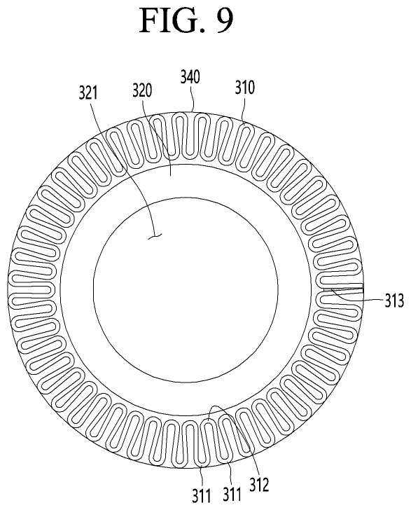

FIG. 7 is a cross-sectional view illustrating another example of a composite filter that is a portion of components of the present invention. FIG. 8 is a perspective view illustrating another example of a post-filter in which the second inner cover is separated. FIG. 9 is a top plan view illustrating another example of the post-filter in which the second inner cover is separated.

Referring to FIGS. 7 to 9, the composite filters may include the hollow fiber membrane filter 200 in which the plurality of hollow fiber membranes 210 are embedded, and the post-filter 300 in which a second carbon block 320 having a hollow tube shape is embedded.

The composite filters, which are main components of the present invention, may be described. The hollow fiber membrane filter 200 and the post-filter 300 may be accommodated in the filter module of the filter housing 400 to constitute the composite filters. The filter module is to include the hollow fiber membrane filter 200 and the post-filter 300.

The hollow fiber membrane filter 200 and the post-filter 300 may be arranged in a line so that the water passing through the hollow fiber membrane filter 200 passes through the post-filter 300. The hollow fiber membrane filter 200 is disposed at a lower side of the filter housing, and the post-filter 300 is disposed at an upper side of the filter housing. The water introduced into the filter housing 400 sequentially passes through the hollow fiber membrane filter 200 and the post-filter 300 while flowing from the lower side to the upper side.

The post-filter 300 includes the second inner cover 330 accommodated inside the filter housing 400, and the second carbon block 320 accommodated inside the second inner cover 330. The electrostatic adsorption nonwoven fabric 310 may be provided between the second inner cover 330 and the second carbon block 320. The electrostatic adsorption nonwoven fabric 310 is provided to surround the outside of the second carbon block 320.

When the electrostatic adsorption nonwoven fabric 310 is provided outside the second carbon block 320, the water introduced into (or inside) the second inner cover 330 passes through the electrostatic adsorption nonwoven fabric 310 and then passes through the second carbon block 320.

As described above, when the water introduced into (or inside) the second inner cover 330 passes through the electrostatic adsorption nonwoven fabric 310, heavy metals (such as chromium (Cr) and selenium (Se)) in the water may be removed.

The electrostatic adsorption nonwoven fabric 310 may also be referred to as a ‘positive charge adsorption nonwoven fabric’ in terms of functionality. The electrostatic adsorption nonwoven fabric 310 is made of a material different from that of the ‘anion nonwoven fabric’. The electrostatic adsorption nonwoven fabric 310 may be provided in multiple layers to improve virus removal efficiency.

The electrostatic adsorption nonwoven fabric 310 may be wrinkled to improve the virus removal efficiency.

Referring to FIGS. 8 to 9, in the electrostatic adsorption nonwoven fabric 310, the wrinkles may be provided along a circumference of the second carbon block 320.

The electrostatic adsorption nonwoven fabric 310 may include a plurality of convex portions 311 convex to the outside of the second carbon block 320 and the concave portions 312 may each be provided between two of the convex portions 311.

In the electrostatic adsorption nonwoven fabric 310, the convex portion 311 and the concave portion 312 may be alternately disposed along the circumference of the second carbon block 320.

When the electrostatic adsorption nonwoven fabric 310 is wrinkled, a surface area of the electrostatic adsorption nonwoven fabric 310 may increase, and heavy metals in water may be more reliably removed.

Referring to FIG. 9, the electrostatic adsorption nonwoven fabric 310 may provide a closed curve by crimping a rectangular nonwoven fabric and thermally fusing the nonwoven fabric in a state in which both ends of the wrinkled nonwoven fabric are in contact with each other. In this state, the electrostatic adsorption nonwoven fabric 310 may be fitted to surround an outer circumferential surface of the second carbon block 320. The electrostatic adsorption nonwoven fabric 310 may be provided with a thermal fusion portion 313 to thermally fuse both the ends of the nonwoven fabric.

As another example, the electrostatic adsorption nonwoven fabric 310 may surround the outer circumferential surface of the second carbon block 320 with the wrinkled nonwoven fabric, and may then be thermally fused such that both the ends of the nonwoven fabric 310 are in contact with each other.

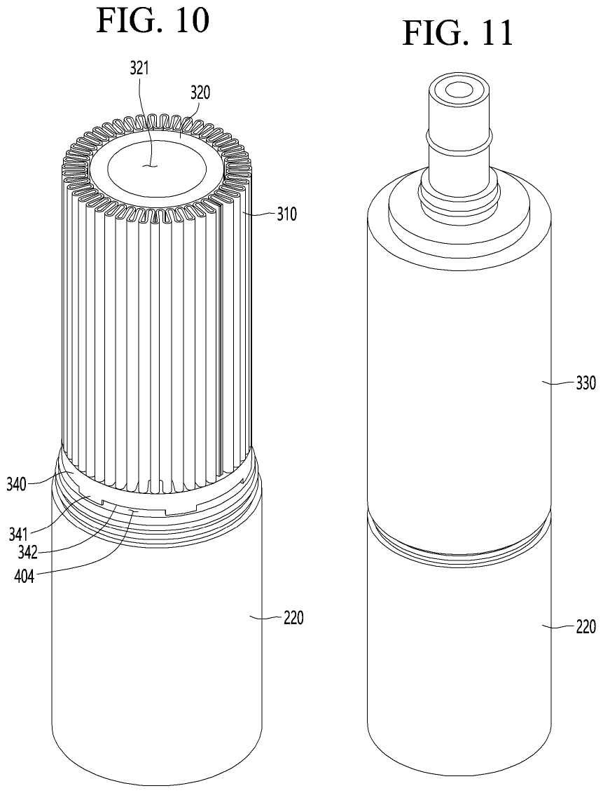

FIG. 10 is a perspective view illustrating a state in which the post-filter and the hollow fiber membrane filter are coupled to each other in the state shown in FIG. 8. FIG. 11 is a perspective view illustrating a state in which the post-filter and the hollow fiber membrane filter are coupled to each other. Inside the filter housing 400, the hollow fiber membrane filter 200 is disposed below the post-filter 300.

The water introduced into the filter housing 400 may pass through the hollow fiber membrane filter 200, and then pass through the post-filter 300. The water introduced into (or inside) the second inner cover 330 of the post-filter 300 may pass through the electrostatic adsorption nonwoven fabric 310 and then pass through the second carbon block 320.

The first inner cover 220 defining an outer appearance of the hollow fiber membrane filter 200 is provided inside the filter housing 400. The hollow fiber membrane filter 200 may include the plurality of hollow fiber membranes 210 and the first inner cover 220 accommodating the hollow fiber membranes 210 therein.

The first inner cover 220 may be disposed below the second inner cover 330. The filter module may include the first and second inner covers and the elements/components within the first and second inner covers. The first inner cover 220 may be detachably coupled to the second inner cover 330. The first inner cover 220 and/or the second inner cover 330 may have a hollow tube shape with upper and lower sides opened.

The communication hole 230 communicating with the inside and the outside of the first inner cover 220 may be defined based on the first inner cover 220.

The water introduced into the filter housing 400 through the inlet 410 flows (upward and) downward along the first passage 401 (FIG. 7) provided between an inner surface of the filter housing 400 and an outer surface of each of the first and second inner covers 220 and 330.

The water flowing downward along the first passage 401 may be introduced into the first inner cover 220 through the communication hole 230 provided at a lower end of the first inner cover 220. The communication hole 230 may be defined by a spaced distance between a lower end of the first inner cover 220 and an inner bottom surface of the filter housing 400.

The water introduced into (or inside) the first inner cover 220 is filtered while passing through the plurality of hollow fiber membranes 210 (UF), being discharged to an upper side of the hollow fiber membrane filter 200, and then being introduced into (or inside) the second inner cover 330.

The upper end of the hollow fiber membrane filter 200 may be in an opened state. The water passing through the plurality of hollow fiber membranes 210 naturally flows toward the upper side of the hollow fiber membrane filter 200 based on the flow of the water introduced into (or inside) the first inner cover 220.

The filter bracket 340 coupled to a lower end of the second carbon block 320 and a lower end of the electrostatic adsorption nonwoven fabric 310 is seated on the upper end of the hollow fiber membrane filter 200. The water discharged to the upper side of the hollow fiber membrane filter 200 flows through the second passage 402 (FIG. 7) provided between the upper side of the hollow fiber membrane filter 200 and a bottom surface of the filter bracket 340.

The upper side of the hollow fiber membrane filter 200 and the filter bracket 340 may be maintained in a spaced state. The water passing through the hollow fiber membrane filter 200 may flow through the second passage 402 (FIG. 7) provided in the spaced space.

A lower end of the electrostatic adsorption nonwoven fabric 310 may be fixed to the filter bracket 340 in a hot melt manner.

In order to secure the second passage 402 (FIG. 7), the filter bracket 340 may include the extension portion 341 protruding downward from a circumferential portion of a bottom surface of the filter bracket, and the through-groove 342 defined to be concave upward from a lower end of the extension portion 341. A plurality of through-grooves 342 may be provided on the extension portion.

The bottom surface of the filter bracket 340 and the upper end of the hollow fiber membrane filter 200 may be spaced apart from each other by the extension portion 341, and thus the second passage 402 (FIG. 7) may be secured.

The water flowing through the second passage 402 may be discharged through the through-groove 342 and the through-hole 404 (FIG. 10) defined by the upper end of the hollow fiber membrane filter 200 and then may be introduced into the third passage 403 (FIG. 7) provided between the electrostatic adsorption nonwoven fabric 310 and the second inner cover 330.

The upper end of the hollow fiber membrane filter 200 and the filter bracket 340 are in a state of being accommodated under the second inner cover 330. Thus, the water flowing through the second passage 402 may be discharged through the through-hole 404 (FIG. 10) and then be introduced into the third passage 403 (FIG. 7).

The water introduced into the third passage 403 sequentially passes through the electrostatic adsorption nonwoven fabric 310 and the second carbon block 320, and then is introduced into a hollow of the second carbon block 320 so as to flow upward. The water is then discharged through the outlet 420 of the filter housing.

An upper end of the first inner cover 220 may be inserted into (or inside) a lower end of the second inner cover 330. The sealing member 500 (or sealant) may be inserted between the upper end of the first inner cover 220 and the lower end of the second inner cover 330.

An accommodation groove that is concave inward to accommodate the sealing member 500 may be defined in a surface facing an outer surface of the first inner cover 220 or an inner surface of the second inner cover 330.

As a modified example, the lower end of the second inner cover 330 may be inserted into the upper end of the first inner cover 220.

The first inner cover 220 and the second inner cover 330 may be integrally formed.

A flow process of water introduced into the composite filters configured as described above may be described. Water may be introduced through the inlet 410 provided at the upper side of the filter housing 400. For example, the introduced water may be water that has passed through the pre-filter 100.

The water introduced into the inlet 410 flows downward (from the upper side) along the first passage 401 provided between the outer surfaces of each of the first and second inner covers 220 and 330 and the inner surface of the filter housing 400.

The water of the first passage 401 is introduced into (or inside) the first inner cover 220 through the communication hole 230 provided below the first inner cover 220. The water introduced into (or inside) the first inner cover 220 passes through the plurality of hollow fiber membranes 210 (accommodated within the first inner cover 220) and is filtered, and then is discharged toward the upper side.

The water discharged from the upper side of the hollow fiber membrane 210 flows through the second passage 402 provided between the upper end of the hollow fiber membrane filter 200 and the filter bracket 340, and is discharged through the through-hole 404.

The water passing through the through-hole 404 is introduced into the third passage 403 provided between the inner surface of the second inner cover 330 and the electrostatic adsorption nonwoven fabric 310. The water introduced into the third passage 403 sequentially passes through the electrostatic adsorption nonwoven fabric 310 and the second carbon block 320 and then flows into the hollow 321 of the second carbon block 320. The water introduced into the hollow 321 may be discharged through the outlet 420 provided at the upper center of the filter housing 400.

The electrostatic adsorption nonwoven fabric 310 may be wrinkled along the circumference of the second carbon block 320 so that the surface area of the electrostatic adsorption nonwoven fabric 310 increases, and heavy metals in water may be more reliably removed.

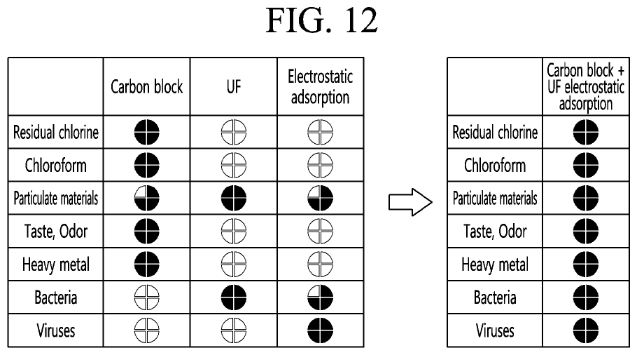

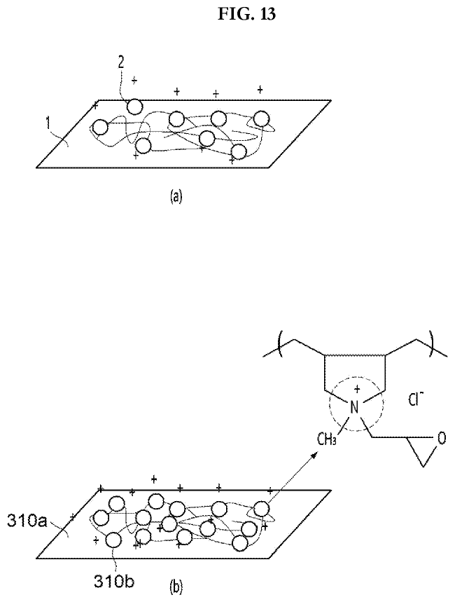

FIG. 12 is a table showing components to be removed for each material constituting the composite filter. In the example of the carbon block, residual chlorine, chloroform, particulate materials, taste, odor, and heavy metals may be removed. In the example of the hollow fiber membrane, particulate materials and bacteria may be removed. In the example of the electrostatic adsorption nonwoven fabric, particulate materials, bacteria, and viruses may be removed.

Therefore, in embodiments of the present invention, when the water introduced into the filter housing sequentially passes through the hollow fiber membrane, the electrostatic adsorption nonwoven fabric, and the carbon block, residual chlorine, chloroform, particulate materials, heavy metals, bacteria, and viruses may be removed.

Since the water introduced into the filter housing passes through the carbon block last, odor may be removed, and the taste of water may be improved.

When the hollow fiber membrane filter 200 and the post-filter 300 are arranged in a line in the filter module of the filter housing 400, filtration efficiency may be improved, and a flow rate of the purified water may be maintained.

It is not necessary to expand the filter installation space defined in the water purifier. The filter may be applied by simply replacing the existing filter.

The filter may be reduced in volume to improve space utilization. Slimming of the water purifier may be achieved.

The pre-filter 100 may be described.

The pre-filter 100 includes a filter housing 110 provided with an inlet 111 and an outlet 112, and a first carbon block 120 may be accommodated inside the filter housing 110.

Each of the first carbon block 120 and the second carbon block 320 may include activated carbon. The activated carbon may be provided in the form of granular or powder. As described above, when the carbon blocks 120 and 320 include activated carbon, the carbon blocks 120 and 320 may effectively remove heavy metals in water and also residual chlorine components in water. Thus, the taste of water may also be improved. Chloroform (CHCL₃) in water may be effectively removed by the activated carbon.

Each of the first carbon block 120 and the second carbon block 320 may include a binder. The binder may connect the activated carbon and the selectively mixed functional material to each other and may be mixed to give rigidity.

Due to the configuration of the binder, the activated carbon and the functional material may be processed in the form of a block having rigidity.

For example, the functional material may include titanium oxide (e.g., Na4TiO₄) and ferric hydroxide (ferric hydroxide). That is, the first carbon block 120 or the second carbon block 320 may be prepared by mixing the activated carbon and the binder and may further include titanium oxide (e.g., Na4TiO₄) and ferric hydroxide (ferric hydroxide).

For reference, the first carbon block 120 and/or the second carbon block 320 may be provided by uniformly mixing a plurality of materials including the activated carbon and the binder and then putting the mixture in a mold and heating the mixture. The binder (e.g., polyethylene (PE)) is melted by being heated in the mold, and materials such as the activated carbon are coupled. Thus, the first carbon block 120 and/or the second carbon block 320 (in the form of a block having overall rigidity) may be provided.

The pre-filter 100 may be accommodated inside the filter housing 110, and the filter bracket 130 coupled to the upper and lower sides of the first carbon block 120 may be further provided.

The upper side of the filter housing 110 may be opened. The opened upper side may be blocked by a separate cap 113 and may be selectively opened depending on whether the cap 113 is detached.

The water introduced into the filter housing 110 through the inlet 111 flows through the passage 101 provided between the inner surface of the filter housing 110 and the first carbon block 120. The water flowing through the passage 101 is filtered while passing through the first carbon block 120 and is introduced into the hollow 121 of the first carbon block 120. Thereafter, while the water in the hollow 121 flows upward, the water is discharged to the outside of the filter housing 110 through the outlet 112, and the discharged water is introduced into the composite filters.

According to example embodiments, as the raw water introduced into the filter housing 110 passes through the first carbon block 120, heavy metals may be removed and purified.

According to the above description, the raw water introduced into the pre-filter 100 passes through the first carbon block 120, then passes through the hollow 121 of the first carbon block 120 and then is discharged to the outside of the pre-filter 100.

The water discharged to the outside of the pre-filter 100 may pass through the hollow fiber membrane filter 200, in which the plurality of hollow fiber membranes 210 are embedded, thus through the second carbon block 320 having the hollow-tube shape, and through the post-filter 300 in which the electrostatic adsorption nonwoven fabric 310 surrounding the circumference of the second carbon block 302 is embedded.

When the pre-filter 100, the hollow fiber membrane filter 200, and the post-filter 300 are provided as described above, water introduced into the filter assembly 17 may be purified several times while passing through the pre-filter 100, the hollow fiber membrane filter 200, and the post-filter 300 to more reliably remove various foreign substances including heavy metals, bacteria, and viruses.

Chlorine and chloroform (CHCL₃) in water may be more reliably removed by the post-filter 300, and thus the taste of water may be improved.

When activated carbon, binder, ferric hydroxide, and titanium oxide are mixed through the first carbon block 120 or the second carbon block 320, nine kinds of heavy metals (i.e., mercury, lead, copper, aluminum, iron, cadmium, arsenic, manganese and zinc) may be removed.

Mercury, lead, iron, aluminum, cadmium, arsenic, and copper are removed by ferric hydroxide in the carbon blocks 120 and 320, and manganese and zinc may be removed by titanium oxide in the carbon blocks 120 and 320.

A process of manufacturing the carbon blocks 120 and 320, which are portions of components of the present invention may be briefly described. Each material constituting the carbon blocks 120 and 320 may be mixed in a proportion to generate a carbon block mixture. The evenly mixed carbon block mixture is filled in the mold. A compression process is then performed on the carbon block mixture, and then the compressed carbon block mixture is put into an electric furnace. Heating may be performed. In the heating process, the binder (for example, polyethylene (PE)) is melted, the activated carbon, ferric hydroxide, titanium oxide, and the binder are integrally coupled, and the carbon blocks 121 and 320 provided in the form of a hollow tube having overall rigidity may be molded.

After the heating, cooling is performed, and when the cooling is completed, the mold is separated.

The hollow tube-shaped carbon block separated from the mold may be cut to a unit length. For example, the second carbon block 320 may be cut to be shorter in length than the first carbon block 120. The cut carbon blocks 120 and 320 are cleaned through injection of compressed air.

Thereafter, the nonwoven fabric around the carbon block, and the top and bottom caps are attached in a hot melt method. Thereafter, a dimensions and weight is checked, and if there are no abnormalities, packaging is performed.

According to example embodiments as described above, residual chlorine, chloroform, particulate materials, taste, odor, and heavy metals contained in water may be removed. Bacteria contained in the water may be removed, and viruses contained in water may be removed.

Since the water introduced into the filter housing passes through the carbon block last, odor may be removed, and the taste of water may be improved.

When the hollow fiber membrane filter and the post-filter are arranged in a line in one filter housing, the filtration efficiency may be improved, and thus the flow rate of the purified water may be maintained.

It is not necessary to expand the filter installation space defined in the water purifier. The filter may be applied by simply replacing the existing filter.

The filter may be reduced in volume to improve space utilization, and also slimming of the water purifier may be achieved.

1. A filter for a liquid purifier, comprising:
a filter housing having an inlet to receive liquid and an outlet to discharge the liquid; and
a filter module provided at the filter housing, and configured to purify liquid introduced through the inlet, and to provide the purified liquid to discharge from the outlet,
wherein the filter module includes an electrostatic adsorption nonwoven fabric having a hollow portion, and
the filter module is configured to receive the liquid received through the inlet, to pass the liquid through the electrostatic adsorption nonwoven fabric and then to discharge the liquid out through the outlet of the filter housing.

2. The filter according to claim 1, wherein the electrostatic adsorption nonwoven fabric includes powdered activated carbon.

3. The filter according to claim 1, wherein the electrostatic adsorption nonwoven fabric includes:
a plurality of convex portions that are convexly protruding outward; and
a plurality of concave portions each being provided between two of the plurality of convex portions,
wherein a plurality of wrinkles are formed along a circumferential direction.

4. The filter according to claim 3, wherein the electrostatic adsorption nonwoven fabric is formed by crimping a rectangular nonwoven fabric and thermally fusing a first end of the rectangular nonwoven fabric to a second end of the rectangular nonwoven fabric.

5. The filter according to claim 1, wherein the electrostatic adsorption nonwoven fabric is provided in multiple layers.

6. The filter according to claim 1, comprising an additional electrostatic adsorption nonwoven fabric configured to surround an outer circumference of the electrostatic adsorption nonwoven fabric.

7. The filter according to claim 1, comprising a carbon block disposed in the hollow portion of the electrostatic adsorption nonwoven fabric, and the carbon block having a hollow tube shape, wherein the carbon block includes activated carbon and a binder,
wherein the filter module is configured such that the liquid introduced into the filter housing passes through the electrostatic adsorption nonwoven fabric, passes through the carbon block, and then is discharged out of the filter housing.

8. The filter according to claim 7, wherein the filter module includes a hollow fiber membrane filter disposed below the electrostatic adsorption nonwoven fabric, and
the filter module is configured such that the liquid introduced into the filter housing first passes through the hollow fiber membrane, and then passes through the electrostatic adsorption nonwoven fabric and the carbon block.

9. The filter according to claim 8, wherein the filter module includes a first inner cover configured to define an outer appearance of the hollow fiber membrane filter and to cover a hollow fiber membrane, and a second inner cover disposed above the first inner cover and is configured to cover the electrostatic adsorption nonwoven fabric.

10. The filter according to claim 9, comprising a communication hole through which an inside of the first inner cover communicates with an outside of the first inner cover, and
wherein the liquid introduced into the filter housing flows downward along a first passage provided between an inner surface of the filter housing and outer surfaces of the first and second inner covers, and the liquid is introduced through the communication and to inside the first inner cover.

11. The filter according to claim 10, wherein the filter module is configured such that the liquid introduced to inside the first inner cover is filtered while passing through the hollow fiber membrane filter, is discharged from an upper side of the hollow fiber membrane filter, and is introduced to inside the second inner cover.

12. The filter according to claim 11, wherein the filter module includes a filter bracket coupled to a lower end of the electrostatic adsorption nonwoven fabric and the carbon block, and the filter bracket is disposed on an upper end of the hollow fiber membrane filter, and
the filter module is configured such that the liquid discharged from the upper side of the hollow fiber membrane filter flows through a second passage provided between the upper side of the hollow fiber membrane filter and the filter bracket.

13. The filter according to claim 12, wherein the filter bracket includes an extension portion protruding downward from a circumference of the filter bracket, and the extension portion includes a through-groove that is concavely defined upward from a lower end of the extension portion, and
the filter module is configured such that the liquid flowing through the second passage is discharged through the through-groove and is introduced into a third passage provided between the electrostatic adsorption nonwoven fabric and the second inner cover.

14. The filter according to claim 13, wherein the filter module is configured such that the liquid introduced into the third passage passes through the electrostatic adsorption nonwoven fabric, is introduced into a hollow of the carbon block to flow upward, and is discharged out from the outlet of the filter housing.

15. The filter according to claim 9, wherein an upper end of the first inner cover is coupled to a lower end of the second inner cover, and
a sealing member is disposed between the upper end of the first inner cover and the lower end of the second inner cover.

16. A liquid purifier comprising at least one or more filters for a liquid purifier to provide purified liquid from raw liquid,
wherein the filter is the filter according to claim 1.

17. A filter comprising:
a filter housing having an inlet to receive a liquid and an outlet to output a purified liquid; and
an electrostatic adsorption nonwoven fabric disposed in the filter housing, and having a hollow portion, and the electrostatic adsorption nonwoven fabric is configured to receive the liquid from the inlet, to purify the liquid, and to provide the purified liquid to be discharged from the outlet.

18. The filter according to claim 17, comprising a carbon block disposed in the hollow portion, and having a hollow tube shape, wherein the carbon block includes activated carbon and a binder,
wherein the liquid received from the inlet passes through the electrostatic adsorption nonwoven fabric, passes through the carbon block and then passes through the hollow portion to the outlet.

19. The filter according to claim 18, comprising a hollow fiber membrane filter disposed in the filter housing below the electrostatic adsorption nonwoven fabric, and
the liquid received from the inlet passes through the hollow fiber membrane, then passes through the electrostatic adsorption nonwoven fabric, then pass through the carbon block, and then passes through the hollow portion to the outlet.

20. A filter comprising:
a filter housing having an inlet to receive a liquid and an outlet to output a purified liquid; and
a filter module disposed within the filter housing, and configured to receive the liquid from the inlet, to purify the received liquid, and to provide the purified liquid to the outlet,
wherein the filter module includes an electrostatic adsorption nonwoven fabric having a hollow portion, and a carbon block disposed within the hollow portion, and the filter module is configured such that the liquid from the inlet is to pass through the electrostatic adsorption nonwoven fabric, to pass through the carbon block, and to pass through the hollow portion to the outlet.
